(19) United States
(12) Patent Application Publication
(10) Pub. No.: US 2013/0041746 A1
(43) Pub. Date: Feb. 14, 2013

(54) Methods and Systems of Electronic Messaging

(71) Applicants: Eran Hollander, Wallingford, PA (US); Andrew John Kese, Berwyn, PA (US); Carrie Jubinski, King of Prussia, PA (US); Nicole Carroll, Hinsdale, IL (US); Allison Lindemann, Philadelphia, PA (US)

(72) Inventors: Eran Hollander, Wallingford, PA (US); Andrew John Kese, Berwyn, PA (US); Carrie Jubinski, King of Prussia, PA (US); Nicole Carroll, Hinsdale, IL (US); Allison Lindemann, Philadelphia, PA (US)

(73) Assignee: Citibank, N.A., New York, NY (US)

(21) Appl. No.: 13/206,598

(22) Filed: Aug. 10, 2011

(51) Int. Cl. G06Q 30/00

(52) U.S. Cl. 705/14.38

(57) ABSTRACT

Methods and systems of electronic messaging for verification and/or authentication purposes using a point of sale terminal and a card transaction processing network involve, for example, receiving data consisting at least in part of a consumer's identifier that is processable through a transaction card processing network and a nominal monetary amount which is an indicator that the data relates at least in part to a coupon redemption for a consumer. Other aspects include, for example, using different nominal amounts to distinguish between multiple promotions and processing overcharges. Additional aspects involve, for example, receiving data consisting at least in part of an identifier for a registrant that is processable through a transaction card processing network and a nominal monetary amount which serves at least in part to identify a command message on behalf of the registrant.

### FIELD OF THE INVENTION

The present invention relates generally to the field of electronic messaging and more particularly to methods and systems for electronic messaging for verification and/or authentication purposes using a point of sale terminal and a card transaction processing network.

### BACKGROUND OF THE INVENTION

Point of sale terminals, including wired and wireless handheld mobile terminals, can be found on the premises of most merchants and service providers or anywhere else payments may be made or received. Such terminals and the infrastructure, such as card transaction processing networks that support use of the terminals, have greatly simplified face-to-face transactions with customers. While point of sale terminals typically provide functionality beyond tracking and processing customer transactions, such as managing inventory, such terminals have yet to realize their full potential.

Presently, discount coupons, which participating retailers may treat as quantity discounts, are popular among consumers worldwide. Such coupons may be distributed in various ways, including, for example, web sites offering printable coupons or download to a mobile phone application. Such prepaid discount coupons may provide merchants, such as restaurants, an opportunity to introduce large numbers of new patrons to their establishments. However, it has been discovered that a certain amount of fraud may exist in the redemption of such coupons. For example, a dishonest coupon purchaser may attempt to fraudulently use the same prepaid coupon on multiple occasions. It is very difficult for the merchant to detect such fraud.

Further, a third party, such as a healthcare insurer, may be the custodian of healthcare-related information, which various entities, such as healthcare providers, may need to access from time-to-time. The insurer may not allow such healthcare providers to access the information of a particular individual absent a request or consent from the individual to furnish the information. Consequently, it may not be possible for a user at a computer terminal in the healthcare provider's office to log on and access the information in real time. In addition, it is common to require valid identification to gain physical access to certain premises. Serious security issues may arise if an unauthorized person gains access to premises, such as a military base, using a means of identification that is bogus. Certain types of identification may be relatively easy for an unauthorized person to fake.

To address these deficiencies, there is a present need for an electronic messaging capability using a point of sale terminal and a card transaction processing network for verification and/or authenticating purposes, such as verifying and/or authenticating individuals and/or the validity of coupons purchased by individuals. A difficulty that may arise in addressing such deficiencies is finding a ubiquitous solution that can be operational everywhere without the need for new development or hardware purchases.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the methods and systems for electronic messaging for verification and/or authentication purposes using a point of sale terminal and a card transaction processing network.

A coupon redemption aspect of embodiments of the invention proposes methods and systems of electronic messaging, for example, for verification and/or authentication purposes, using a point of sale terminal and a card transaction processing network, that involve receiving, using a point of sale terminal processor, entry of transaction data consisting at least in part of an identifier, such as a consumer's membership account number, that is processable through a transaction card processing network. In addition, the transaction data may include discount coupon information and a nominal monetary transaction amount which serves as an indicator or message that the data relates at least in part to a discount coupon redemption for the consumer. The nominal amount is not an actual transaction amount.

The transaction data is sent, using the point of sale terminal processor, to an issuer processor, such as a membership issuer processor, via the transaction card processing network. Based on the nominal monetary transaction amount in the transaction data, the transaction is recognized, using the membership issuer processor, to relate at least in part to the discount coupon redemption. Consequently, the transaction data is routed to a database, such as a coupon database storing a membership account file for the consumer, together with details of issuance of the discount coupon to the consumer. Using a coupon database processor, the details of issuance of the discount coupon are confirmed from the stored membership account file, and a message is sent to the point of sale terminal processor verifying the validity of the coupon being redeemed for the consumer.

In embodiments of the invention, the consumer's identifier, such as his or her membership account number, may be received from a consumer's membership account card, for example, by swiping the consumer's membership account card through the point of sale terminal. The point of sale terminal may be a special club terminal other than an unmodified pre-existing standard point of sale terminal. In addition, the special club terminal may be wireless. In other embodiments, the consumer's identifier or membership account number may be received from a mobile phone application or printed on a computer printout. Further, the consumer's identifier or membership account number may be identical to a credit or debit card account number of the consumer.

The nominal monetary transaction amount in embodiments of the invention may be any nominal monetary amount less than one dollar, such as twenty or twenty-five cents or less. As previously noted, the nominal amount is not an actual transaction amount. In a multiple promotions coupon redemption aspect, the nominal monetary transaction amount may be a predetermined nominal monetary amount which serves as a message that the transaction data relates at least in part to a redemption of a coupon in a particular one of a plurality of different coupon programs. According to embodiments of the invention, the transaction data may be sent to the membership issuer processor via a merchant's acquirer processor.

In an overage aspect, the point of sale terminal processor may be a processor of a special club terminal other than an unmodified pre-existing standard point of sale terminal, and entry of the transaction data may be received using the special club terminal processor. In such aspect, the entered transaction data may consist at least in part of a monetary amount of an overage transaction to be charged against a credit or debit card account linked, for example, to the consumer's membership account.

In the overage aspect, the transaction data may be routed to the coupon database storing the membership account file of the consumer that consists at least in part of details of the linked credit or debit card account of the consumer. Using the coupon database processor, it may be confirmed that the membership issuer is authorized to function as a merchant's acquirer, or has a working relationship with the merchant's acquirer, to settle transactions for the merchant.

In such aspect, upon confirming that the membership issuer is authorized to function as a merchant's acquirer, or has a working relationship with the merchant's acquirer, to settle transactions for the merchant, the transaction data may be routed to a credit card issuer processor. Using the credit card issuer processor, the linked credit or debit card may also be confirmed to be is in good standing and have sufficient credit limits to cover the overage amount. Upon confirming that the linked credit or debit card is in good standing and has sufficient credit limits to cover the overage amount, a message may be sent to the point of sale terminal processor verifying the validity of the coupon sought be redeemed for the consumer and authorizing the overage charge against the consumer's linked credit or debit card account.

An information access aspect of embodiments of the invention proposes methods and systems of electronic messaging, for example, for verification and/or authentication purposes, using a client device, such as a point of sale terminal and a card transaction processing network. Such embodiments involve, for example, receiving, using a client device processor, entry of data consisting at least in part of an identifier for a registrant that is processable through a transaction card processing network. In addition, the data may include a nominal monetary amount which serves at least in part to identify a command message, such as an authorization for a third party to access stored electronic data related to the registrant.

In the information access aspect, the data is sent, using the client device processor, via the transaction card processing network to a command message processor. Based on the nominal monetary amount in the data, the data is recognized, using the command message processor, as relating at least in part to the command message. The data is then routed, using the command message processor, to a command message database storing a file for the registrant. Using a command message database processor, an identity of the registrant and the command message identified by the nominal monetary amount is confirmed from the stored file, and the command message comprising, for example, an authorization for a third party to access stored electronic data related to the registrant is sent, using the command message database processor, to the client device processor on behalf of the registrant.

A physical premises access aspect of embodiments of the invention proposes methods and systems of electronic messaging, for example, for verification and/or authentication purposes, using a client device, such as a point of sale terminal and a card transaction processing network. Such embodiments involve, for example, receiving, using a client device processor, entry of data consisting at least in part of an identifier for a registrant that is processable through a transaction card processing network. In addition, the data may include a nominal monetary amount which serves at least in part to identify a command message, such as an authorization for the registrant to enter a physical premises.

In the physical premises access aspect, the data is sent, using the client device processor, via the transaction card processing network to a command message processor. Based on the nominal monetary amount in the data, the data is recognized, using the command message processor, as relating at least in part to the command message. The data is then routed, using the command message processor, to a command message database storing a file for the registrant. Using a command message database processor, an identity of the registrant and the command message identified by the nominal monetary amount is confirmed from the stored file, and the command message comprising, for example, an authorization for the registrant to enter a physical premises is sent, using the command message database processor, to the client device processor on behalf of the registrant.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that illustrates an overview example of key components and the flow of information between the key components of the coupon redemption aspect system for embodiments of the invention;

FIG. 2 is a flow chart that illustrates an example of the process of coupon redemption for embodiments of the invention; and

FIG. 3 is a schematic diagram that illustrates an overview example of key components and the flow of information between the key components of the coupon redemption aspect system using a special club terminal for embodiments of the invention;

FIGS. 4A and 4B show a flow chart that illustrates an example of the overage aspect of the process of coupon redemption using the special club terminal for embodiments of the invention;

FIG. 5 is a schematic diagram that illustrates an overview example of key components and the flow of information between the key components of the messaging aspect system for allowing access to electronic information or allowing physical access to premises for embodiments of the invention; and

FIG. 6 is flow chart that illustrates an example of the process of messaging allowing access to electronic information or allowing physical access to premises for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention may use an existing card processing network, such as a card association card processing network, to convey information from a point of sale terminal to a third party, based upon which information the third party may take some action. In a coupon redemption aspect, such action may be to verify the validity of a coupon, such as a discount coupon, and notify a merchant of the coupon's validity. Other aspects include, for example, allowing computer access to data, such as healthcare data, based on information received by a third party from a point of sale terminal via a card processing network. Still other aspects include, for example, authorizing physical access to a facility, such as a military facility, based on information received by a third party from a point of sale terminal via a card processing network.

The coupon redemption aspect of embodiments of the invention may involve, for example, authenticating or verifying coupons using card association transaction processing networks in which a nominal amount may be entered at a merchant's existing point of sale transaction terminal to identify the coupon promotion and processed through the card association network. It is to be understood that the nominal amount is a very small amount from one cent to a few cents, but in no event, more than one dollar. Embodiments of the invention may provide a consumer with a unique identifier, such as a sixteen-digit account number or membership number. The unique identifier may be similar to standard fourteen or sixteen digit primary account number (PAN) mechanisms such as the bank identification number (BIN) by which merchants can process payments through a card association transaction processing network. Embedded in such PAN numbers is sufficient information to determine, among other things, the cardholder, with which the card association network the number is associated, and the identity of the issuing bank. The unique identifier may be created, for example, in cooperation with one or more card association processing networks to enable the identifier to be processed through a card association network.

A database may also be provided to which the consumer can log on and register the consumer's details, including, without limitation, the consumer's identification and set up a membership account. The consumer may then be assigned the sixteen digit membership account number as his or her unique identifier. The consumer may also have his or her unique identifier associated with multiple loyalty programs. When the consumer sees a coupon or the like in which he or she is interested, the consumer may log into the consumer's membership account and download the coupon to the consumer's account.

In the registration details initially provided by the consumer, the consumer may also furnish a regular sixteen digit card PAN number for a consumer's transaction account, such as a regular credit or debit card account number. The regular credit or debit card account may be linked to the consumer's membership account. Thus, a transaction card account, such as a debit or credit card account may be linked to the consumer's membership account. Thus, in one aspect of embodiments of the invention, a charge for a coupon purchased by the consumer may be automatically posted to the consumer's linked credit or debit card account when the consumer purchases the coupon. In another aspect, the charge may be automatically made when the consumer's membership card is presented to a merchant.

When presented by the consumer to a participating merchant, the sixteen digit membership account number may be scanned, swiped, tapped (i.e., contactless smart card), or keyed in at the merchant's existing point of sale terminal. In order to identify the transaction as a coupon redemption, instead of inputting a dollar amount for the transaction, the merchant may simply enter a nominal amount, such as one or two cents for the transaction. The nominal amount entered does not represent an actual transaction amount that is charged to the consumer's account but serves only to identify a coupon redemption transaction. The consumer's card number may be routed via a card association transaction processing network to the database of the card issuer, which may be the financial institution. The nominal amount may be recognized at the database to indicate a coupon redemption transaction. The database may then be checked to confirm the identity of the merchant from whose terminal the card number was received and the identity of the consumer. The database may also be checked to confirm that the coupon which the cardholder has presented to the merchant for redemption is a valid coupon. Upon confirming the validity of the consumer's coupon, a message may be sent to the merchant's terminal verifying the validity of the coupon. The merchant may then allow the cardholder to redeem the coupon. The form of verification may be by presenting a message, such as a decline/approve message.

A multiple coupon program feature of the coupon redemption aspect of embodiments of the invention may involve, for example, providing the sixteen digit membership account number, either as a physical card or simply a number downloaded to a mobile phone application or printed out at a computing device. The sixteen digit membership account number may be used with multiple coupon programs by entering one of several nominal amounts, such as one or two to three cents, to distinguish between the multiple promotions and to identify a particular promotion, again processing the transaction via a card association transaction processing network. In addition, a nominal amount, such as $0.03, may communicate a simultaneous redemption attempt of several coupons.

A merchant may typically have multiple discount or couponing programs in progress at any given time. For example, a merchant may have a program that gives a ten percent discount on a $100 purchase or a twenty percent discount on a $200 purchase. In order to distinguish between such programs and associate a particular coupon with a particular program, embodiments of the invention may distinguish between the multiple programs using low value transactions, such as two cents, three cents, four cents, etc. Thus, a two cents nominal amount may be entered at the point of sale terminal to identify a coupon for one couponing program and a three cents nominal amount may be entered at the terminal to identify a coupon for another couponing program. As previously noted, the nominal amounts entered for such purpose do not represent an actual transaction amount that is charged to the consumer's account.

In the multiple coupon program feature of the coupon redemption aspect, a consumer may log on and decide to become a member. The consumer may log on the membership site and furnish the consumer's details. The consumer may also furnish a transaction card account number, such as the consumer's credit or debit card account number, to be linked to the consumer's membership account. Assume, for example, that the consumer decides to purchase a coupon for a massage, which is a $50 value, for a cost of $25. When the consumer logs on to purchase the coupon, the $25 cost may automatically be charged to the consumer's credit or debit card account that is linked to the consumer's membership account.

In embodiments of the invention, a card may be issued with the coupon having the consumer's sixteen digit membership account number on the card. Alternatively, the coupon or the sixteen digit membership account number may be downloaded to an application on the consumer's mobile phone. In the case of the mobile phone application, the consumer may take the consumer's mobile phone to the point of sale. If there is a barcode reader available at the point of sale, the barcode reader may be used to input the sixteen digit membership account number. Otherwise, if there is not a barcode reader at the point of sale, the sixteen digit membership account number may be manually input by typing it on an input device of the point of sale terminal, or if a contactless feature is available, the input may be accomplished, for example, by a tap of the card or mobile device. In the case of the card or coupon, the card or coupon with the sixteen digit membership account number may be swiped in the merchant point of sale terminal. Alternatively, the sixteen digit membership account number may be manually input in the merchant point of sale terminal.

Merchants may be trained in advance by participating in a training program when they sign up for the program for embodiments of the invention. Thus, in the foregoing example, the merchant may be aware that that the consumer bought a coupon for a massage for $25. The merchant will also be aware that it has a second coupon on offer that entitles a purchaser to a full body wrap for a $50 coupon purchase. In the multiple coupon program aspect of embodiments of the invention, the $25 massage may be identified by entry of a two cents nominal amount, while the $50 body wrap may be identified by entry of a three cents nominal amount.

In order to identify the $25 massage offering, the merchant may swipe the consumer's membership account card in the merchant terminal, but instead of inputting a dollar amount for the purchase, the merchant may simply enter the two cents nominal amount. Thereupon, the consumer's membership account card number may be routed via a card association transaction processing network to the database of the card issuer, which may be the financial institution. The database may then be checked to confirm the identity of the merchant from whose terminal the card number was received and the identity of the consumer. The database may also be checked to confirm that the cardholder has a coupon associated with the $25 massage identified from entry at the point of sale terminal of the two cents nominal amount. Having confirmed the validity of the consumer's $25 massage coupon, a message may be sent to the merchant's point of sale terminal verifying the validity of the coupon. The merchant may then allow the cardholder to redeem the $25 coupon for a massage.

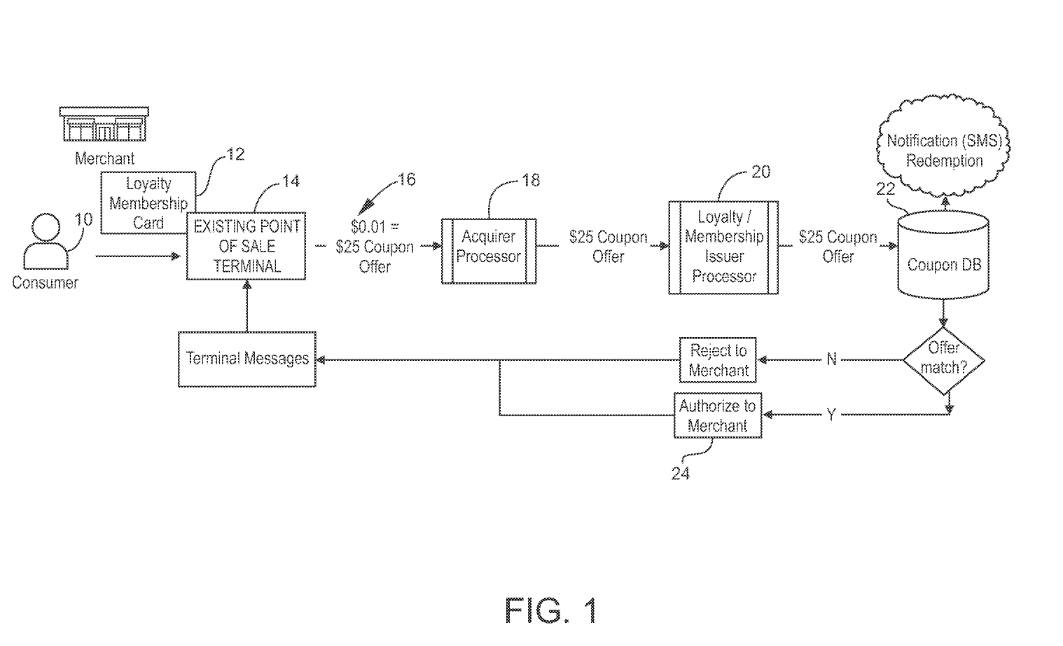

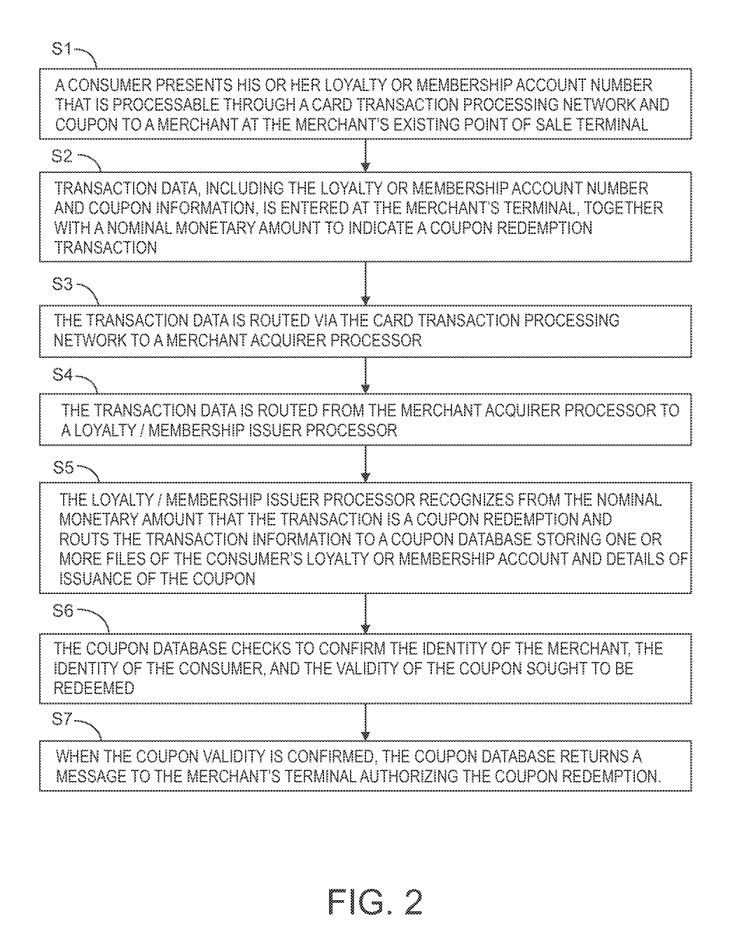

FIG. 1 is a schematic diagram that illustrates an overview example of key components and the flow of information between the key components of the coupon redemption system for embodiments of the invention. FIG. 2 is a flow chart that illustrates an example of the process of coupon redemption for embodiments of the invention. Referring to FIGS. 1 and 2, at S1, a consumer 10 may present his or her membership account number and coupon, for example, on a membership account card 12, a mobile phone application, or a computer print-out, to a merchant for redemption at the merchant's point of sale terminal 14. The consumer's account number is a PAN number processable through a transaction card-processing network, such as a card association network. At S2, transaction data, including the membership account number and coupon information, may be entered at the merchant's terminal 14, together with a nominal amount 16 to indicate a coupon redemption transaction. In the multiple coupon program aspect, if the merchant has more than one program in progress, a nominal amount may be entered that corresponds to the particular program for which the particular coupon presented by the consumer 10 for redemption was issued. The nominal monetary transaction amount is only an indicator that the data relates to a discount coupon redemption and is not charged to the consumer. While the nominal monetary transaction amount is typically only a few cents, it may be some greater amount, but in no event greater than one dollar.

Referring further to FIGS. 1 and 2, at S3, the transaction data is routed via a network, such as a card association transaction-processing network, to a merchant acquirer processor 18. At S4, from the merchant acquirer processor 18, the transaction data is routed to a membership issuer processor 20. At S5, the membership issuer processor 20 recognizes from the nominal amount that the transaction is a coupon redemption and routs the transaction information to a coupon database 22 storing one or more files, for example, of the membership account of the consumer 10 and details of issuance of the coupon. At S6, the coupon database 22 checks to confirm, for example, the identity of the merchant from whose terminal 14 the transaction data was received, the identity of the consumer 10, and the validity of the coupon sought to be redeemed. As noted above, if the merchant has more than one coupon program in progress, the particular program for which the coupon sought to be redeemed is associated may also be identified from the nominal amount. At S7, when the coupon validity is confirmed, the coupon database 22 returns a message 24 to the merchant's point of sale terminal 14 authorizing the coupon redemption.

An overage feature of the coupon redemption aspect of embodiments of the invention may involve, for example, providing a special club terminal, as opposed to an existing standard unmodified retail point of sale device. In the overage aspect, the sixteen digit membership account number is linked to a transaction card account, such as a credit or debit card account of the consumer, for covering overages. Thus, the coupon redemption and payment of overages may be accomplished with one swipe of the transaction card through the special club terminal. The overage aspect may allow a consumer to make one or more additional purchases in addition to redeeming the coupon for which the consumer already prepaid.

In the overage aspect, the merchant may be provided with the special club terminal to accommodate payment for such additional purchases. The special club terminal may allow a consumer to redeem the consumer's prepaid coupon and charge additional purchase amounts with a single swipe of the consumer's membership account card. In this aspect, the financial institution may have both a card issuing relationship with the consumer and an acquirer relationship with the merchant. The special club terminal may be a wired or a wireless terminal. The special club terminal may be provided in addition to an existing merchant point of sale terminal or it may simply replace the existing merchant point of sale terminal.

Assume, for example, that the consumer uses the sixteen-digit account number to download multiple coupons, such as ten different coupons, to the consumer's account. It is to be noted that the couponing card may not be a credit card. In this regard, it is to be noted that the term “card” as used herein includes, without limitation, any and all types of virtual and physical cards and tokens, no matter what their primary functions or uses may be. Instead, it is may be a specific membership account card that has the sixteen digit account number. It is to be further noted that there are no funds stored on the membership account card but that the membership account may be loaded and reloaded with multiple coupons. Assume also that the special club terminal is deployed at the merchant's point of sale. Thus, the financial institution may control both the front end and the back end of transactions using the special club terminal. The consumer may go to the specific merchant to redeem one or more of the ten coupons by swiping the consumer's couponing card through the special club terminal.

In this example, assume that a first coupon offer of the ten coupon offers may be identified by a one cent nominal amount entry on the special club terminal and a second coupon offer of the ten coupon offers may be identified by a two cents nominal amount entry on the special club terminal and so on. When the membership account card is swiped in the special club terminal, the one cent nominal amount entered at the terminal may be sent to the membership database. In such case, the consumer and the first coupon offer are identified and validated, and an authorization message may be returned to the merchant via the special club terminal.

The foregoing example describes the process for embodiments of the invention in which the merchant has the special club terminal at the point of sale. The special club terminal may also accept all other transaction card account payments, whether or not coupons are involved in a transaction. Thus, the special club terminal for embodiments of the invention may replace the merchant's existing point of sale terminal. As noted above, when the membership card is swiped in the special club terminal, the nominal amount, such as a one cent or two cents nominal amount may be sent to the database, which may confirm the consumer's coupon and authorize the transaction. However, in the event of an overage, the overage may also be processed and charged against the transaction card account, such as the credit or debit card account that was previously linked by the consumer to the membership account.

As previously noted, when the consumer registers for the membership account card and purchases one of more coupons, the consumer may link the consumer's credit or debit card account that was used to purchase the coupon to the consumer's membership account. In the registration process, the consumer may indicate that he or she wants the linked credit or debit card account to be used for any overages. Thus, when the membership account card is swiped at the special club terminal, if there is an overage, such as an upgrade from the basic service for which the coupon was purchased, the overage may be charged to the credit or debit card account linked to the membership account.

Thus, instead of handing the merchant a credit or debit card or cash to pay the overage, both the coupon redemption and payment of the overage can be accomplished with a single swipe of the membership account card through the special club terminal. The coupon transaction is sent to the database and authorized, and at the same time, the overage is charged against the credit or debit card account that was linked to the membership account. At the special club terminal, a credit card receipt for the overage transaction may then be printed out showing only the amount of the overage, which the consumer may asked to sign in the usual manner.

As also previously noted, the special club terminal may stand alongside the merchant's existing point of sale terminal or it may replace the existing terminal. Currently, some merchants have existing agreements, for example, with merchant acquiring banks that may not permit the merchant to fully replace the merchant's existing point of sale terminal. In such cases, the special club terminal may simply sit beside the existing terminal at the point of sale. However, there may incentives for such merchants to employ the special club terminal for all point of sale transactions because use of the special club terminal may involve lower interchange rates than those experienced in use of the merchant's existing point of sale terminal.

As likewise previously noted, a particular merchant may be contractually bound to continue using the merchant's existing point of sale terminal for some or all transactions. In such cases, the merchant may do so and use the special club terminal only for membership account card transactions. Such merchants, however, may eventually transition all of their transactions to the special club terminal. Transactions using the membership number may be processed through one of the same card association processing networks, such as the VISA® or MASTERCARD® card processing networks, through which card transactions, such as credit card transactions, are processed.

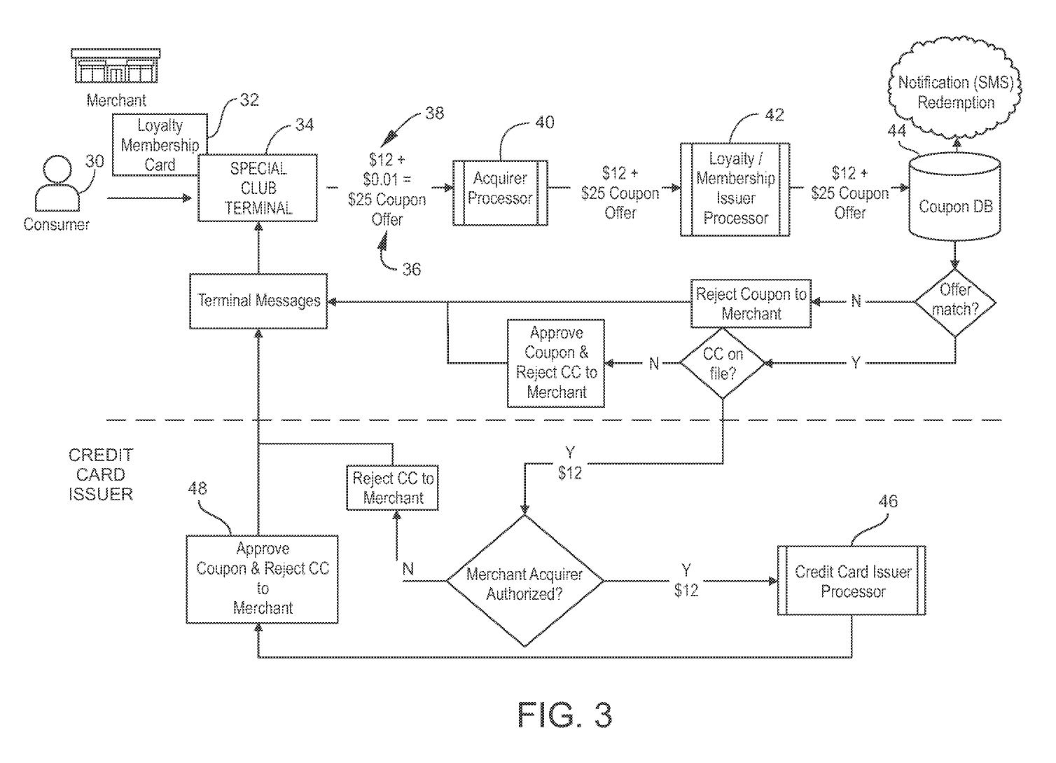

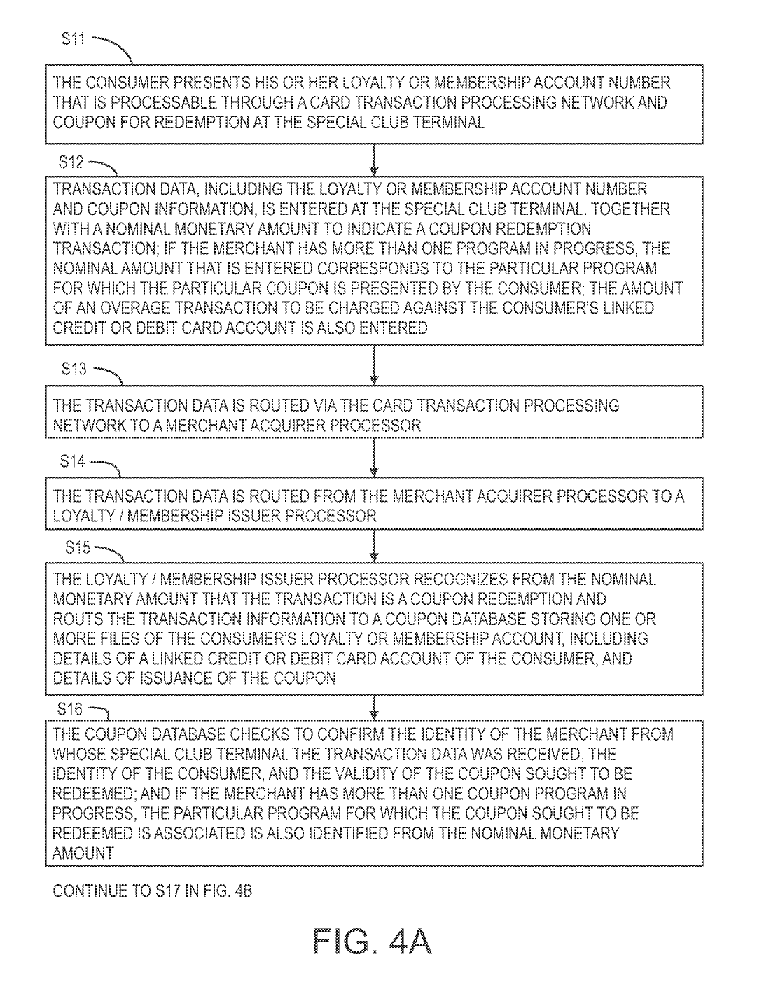

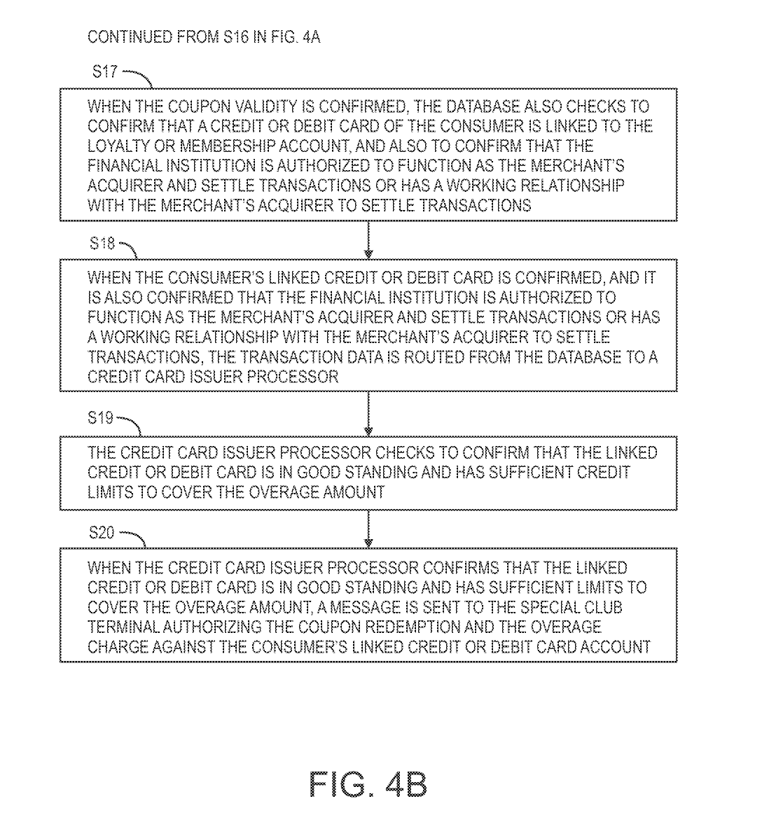

In transactions using the special club terminal for embodiments of the invention, the financial institution may function as both the card issuer and also handle the settlement of transactions. Thus, the financial institution may become the merchant's acquirer and settle transactions, handling overages and performing various accounting functions. FIG. 3 is a schematic diagram that illustrates an overview example of key components and the flow of information between the key components of the coupon redemption system using a special club terminal for embodiments of the invention. FIGS. 4A and 4B show a flow chart that illustrates an example of the overage feature of the coupon redemption aspect process using the special club terminal for embodiments of the invention.

Referring to FIGS. 3 and 4A, at S11, the consumer 30 may present his or her membership account number and coupon, for example, on a membership account card 32, a mobile phone application, or a computer print-out, to a merchant for redemption at the special club terminal 34. At S12, transaction data, including the membership account number and coupon information, may be entered at the special club terminal 34, together with a nominal amount 36, such as one cent, to indicate a coupon redemption transaction. In the multiple coupon program aspect, if the merchant has more than one coupon program in progress, the nominal amount that is entered may correspond to the particular program for which the particular coupon presented by the consumer 30 for redemption was issued. Further, in the overage aspect, the amount of the overage transaction 38, such as $12, to be charged against the consumer's linked credit or debit card account may also be entered.

Referring further to FIGS. 3 and 4A, at S13, the transaction data is routed via a card transaction-processing network, to a merchant acquirer processor 40. At S14, the transaction data is routed from the merchant acquirer processor 40 to a membership issuer processor 42. At S15, the membership issuer processor 42 recognizes from the nominal amount 38 that the transaction is a coupon redemption and routs the transaction information to a coupon database 44 storing one or more files, for example, of the membership account of the consumer 30, including details of a linked credit or debit card account of the consumer 30, and details of issuance of the coupon sought to be redeemed.

Referring again to FIGS. 3, 4A, and 4B, at S16, the coupon database 44 checks to confirm, for example, the identity of the merchant from whose special club terminal 34 the transaction data was received, the identity of the consumer 30, and the validity of the coupon sought to be redeemed. As noted above, if the merchant has more than one coupon program in progress, the particular program with which the coupon sought to be redeemed is associated may also be identified from the nominal amount 36. At S17, when the coupon validity is confirmed, the database 44 checks to confirm that a credit or debit card of the consumer is linked to the membership account, and also to confirm that the financial institution is authorized to function as the merchant's acquirer and settle transactions or has a working relationship with the merchant's acquirer to settle transactions for the merchant.

Referring once more to FIGS. 3, 4A, and 4B, at S18, when the consumer's linked credit or debit card is confirmed, and it is confirmed that the financial institution is authorized to function as the merchant's acquirer and settle transactions or has a working relationship with the merchant's acquirer to settle transactions, the transaction data is routed from the database 44 to a credit card issuer processor 46. At S19, the credit card issuer processor 46 checks to confirm that the linked credit or debit card is in good standing and has sufficient credit limits to cover the overage amount. At S 21, when the credit card issuer processor 46 confirms that the linked credit or debit card is in good standing and has sufficient limits to cover the overage amount, a message 48 is sent to the special club terminal 34 authorizing the coupon redemption and the overage charge against the consumer's linked credit or debit card account.

Under current practice, every authorization must be accompanied by clearing and settlement, so in a transaction that includes a prepaid coupon transaction plus an overage transaction, both the original coupon purchase and the overage must be accounted for. Assume, for example, a $37 total transaction involving a $25 coupon redemption and a $12 overage charge. The result may be a $37 transaction authorization and a $12 settlement, so the books of the merchant may not balance. Therefore, it is not presently feasible to perform both coupon redemptions and overage transactions with a single swipe of the membership card through a merchant's existing standard unmodified retail point of sale point of sale terminal.

In embodiments of the invention, the financial institution may always be the issuer of the membership account. The financial institution may also, but not necessarily, be the merchant acquirer in transactions using the membership account. For transactions in which the financial institution is not the acquirer, it may be necessary for the financial institution to have a working relationship with the merchant acquirer. It may not be feasible for the financial institution to arrange a working relationship with numerous different acquirers for many different small businesses. However, it may be feasible for the financial institution to arrange such a relationship with a single acquirer for a major merchant, such as a major retail chain.

Embodiments of the invention may involve use of the sixteen digit membership account number separately from a credit card. Other embodiments may involve use of a separate card with the sixteen digit membership account number. Additional embodiments may involve linking an existing credit card and using the credit card account number as the membership account identifier. For example, the credit or debit card account number of a consumer may be associated with the consumer's membership account at the time the consumer registers for the membership account. Thus, the credit or debit card account number also functions as the sixteen digit membership account number, for example, for couponing. When the consumer's credit or debit card is swiped at one of the special club terminals deployed by the financial institution, the transaction may be sent to the financial institution as the issuer for authorization of the consumer's coupon.

In the registration process for embodiments of the invention, a consumer may log on to the financial institution's couponing program website. The consumer may be assigned a new sixteen digit membership account number. The sixteen digit membership account number may be broken apart, for example, into two digits and fourteen digits so it does not necessarily look like a card association account number. The consumer may also link one of the consumer's existing credit, debit, or prepaid card accounts to the consumer's membership account. When the consumer returns to the financial institution's couponing site or goes to another couponing site, any purchase that the consumer makes may be automatically charged to the linked card of the consumer. The sixteen digit membership account number may be virtual or it may be a mobile wallet. It may also be a number that the consumer can write down or a number that is printed out on a piece of paper with a coupon. The consumer may actually be given a membership account number by the financial institution for couponing. At the same time, the consumer may have his or her existing credit or debit card account linked to the membership account number.

When the consumer goes to redeem coupons that he or she has purchased, the consumer may not need to show a physical card. Instead, the consumer may present his or her membership account card or show his or her mobile phone with the consumer's membership account number or present a piece of paper on which the membership account number is printed. At that point, the merchant, who has been trained in advance, knows exactly what to do. At the point of sale, if there is no overage and assuming the consumer received the service associated with the coupon, the merchant may type in on the merchant's existing point of sale terminal the service and a nominal amount, such as two cents, that may identify the particular promotion and the consumer's membership account number. The transaction may be routed via the card association transaction-processing network to the acquirer. At the acquirer, the database may be checked against the merchant identification, the membership account number, and the nominal amount to confirm that the consumer's coupon is valid. If so, an authorization may be sent back to the merchant.

Embodiments of the invention may involve significant return on investment for merchants. For example, merchants may typically benefit from lowering one of their largest transaction costs, which is the merchant discount rate. A card transaction processing company may be persuaded to cooperate in reducing such costs for transactions. For example, the financial institution may own both the front end and the back end of the transaction by both being the issuer of the membership account and deploying the special club terminals. Such special club terminals may have a relatively low cost and may be wireless. Further, such special club terminals may not necessarily replace the merchants' existing terminals in cases in which the merchant has a contractual obligation that prevents such replacement. In such cases, the special club terminals may be deployed alongside the merchants' existing point of sale terminals.

Over time, it may be expected that merchants, having an opportunity to compare the features of the special club terminals with their existing point of sale terminals, will recognize the advantages of utilizing the special club terminals for all of their transactions. In addition to simplifying the merchants' couponing transactions and enabling merchants to develop and expand loyalty programs and realize substantial value from new consumers, such merchants may also reduce one of their largest line item costs, namely their merchant acquiring costs. Such deployment of the special club terminal for embodiments of the invention may enable use of a transaction card account number, such as a credit or debit card account number, issued by the financial institution as the identifier for a consumer's couponing transactions. Further, such deployment means that the financial institution functions both as the issuer and the acquirer, and coupon redemption and payment of an overage can be performed with a single swipe of the membership account card through the special club terminal.

For example, a consumer may perform a $37 total transaction involving a $25 coupon redemption and a $12 overage with a single swipe through the special club terminal of the consumer's membership account card that is linked to a credit or debit card account of the consumer. In such example, when the consumer's membership account card is swiped through the special club terminal, the $37 transaction, including the $25 coupon, may be routed back to the membership database and recognized as a $25 coupon redemption with a $12 overage amount. An authorization message may be returned to the merchant for the $25 coupon redemption, as well as for the $12 overage charge to the consumer's linked credit or debit card account. From a settlement perspective, instead of an out-of-balance $37 transaction authorization and $12 settlement for the merchant using the merchant's existing point of sale terminal, the transaction is recognized as a balanced $12 transaction authorization and a $12 settlement.

Another potential advantage of such deployment of the special club terminal for embodiments of the invention is that since the financial institution is both the issuer and the acquirer, it may be possible to avoid processing transactions through a card association network. Such transactions may be referred to as “on-us” transactions and may alternatively be processed by the financial institution or by arrangement with a card transaction processor other than a card association network. Such alternative processing may avoid card association fees and may thus be less expensive.

It is to be understood, however, that embodiments of the invention are not limited to functionality, such as coupon redemption. On the contrary, as previously noted, embodiments of the invention may use an existing card processing network, such as a card association card transaction processing network, to convey different types of information from a point of sale terminal to a third party, based upon which information the third party may take some action. In the coupon redemption aspect, that action may be to allow the consumer to redeem a discount coupon. Other aspects include, for example, allowing computer access to information, such as healthcare data or authorizing physical access to a facility, such as a military base.

For example, in a an electronic healthcare information aspect of embodiments of the invention, a third party, such as a healthcare insurer, may be the custodian of electronic healthcare-related information, to which various entities, such as healthcare providers, may need computer access from time-to-time. The insurer may not allow such healthcare providers to access the information of a particular individual absent a request or consent from the individual to furnish the information. Embodiments of the invention enable the third party, such as the insurer, to verify that a person whose information is requested, for example, by a user in a healthcare provider's office is present in the office of the healthcare provider and cooperating in the request.

In the healthcare sector example, assume that a user in the office of a healthcare provider logs on to a web site of a healthcare insurer using a password, username or similar mechanism. Assume also that the user attempts to access information about an individual in the healthcare insurer's system. Assume further that the individual, who is present in the healthcare provider's office, has previously registered or was given along with an ID, for example, a sixteen-digit account number, including a BIN number, which can be processed through a network, such as a credit or debit card transaction processing network.

When the user in the healthcare provider's office requests access to the individual's information, the healthcare insurer's system may prompt the user, for example, to ask the individual to swipe or tap his or her card bearing the individual's sixteen-digit account number in the healthcare provider's point of sale terminal or alternatively, to manually enter the sixteen-digit number on the terminal. The purpose of swiping the individual's card or manually entering the individual's number sixteen-digit account number is to verify that the individual is present with the user in the healthcare provider's office and acquiescing in the user's request for access to the individual's information.

At the same time, a nominal amount, such as one cent, may also be entered at the point of sale terminal by the user. The nominal amount does not represent an actual transaction amount but serves, for example, as a message from the individual to the healthcare insurer's system consenting to allow the user to access the individual's information on the healthcare insurer's system. Upon receiving the individual's sixteen-digit number and the nominal transaction amount by the healthcare insurer's system, the healthcare insurer's system allows the user in the healthcare provider's office to access the individual's information on the healthcare insurer's web site.

The foregoing is an example of embodiments of the invention, which do not involve coupon redemption but only the flow of information from a point of sale terminal through a card transaction processing network. An advantage of such embodiments is that they do not require any new hardware or software at the point of sale, such as the office of the healthcare provider. Nor is it necessary for the individual to have a card to swipe at the point of sale terminal. Instead, the sixteen-digit number may be entered manually on the point of sale terminal.

In embodiments of the invention, the individual may be provided with a mobile application on his or her mobile device. Instead of a point of sale terminal, the individual may use the application on the mobile device to send his or her sixteen-digit number and a nominal transaction amount via a merchant acquirer and card transaction processing network to a recipient's system. The individual may register the sixteen-digit number with the recipient's system in advance. Various different nominal transaction amounts may be designated and understood to represent specific messages. For example, a one-cent nominal transaction amount may represent the message “Authorize” from the individual to the recipient's system.

In further embodiments of the invention, the sixteen-digit number may be a virtual account number. A key feature of embodiments of the invention is the sixteen-digit number or similar number that is processable through a card processing network, such as a card association transaction processing network. Other key features may include, for example, an expiration date and information, such as a command, evidenced by the nominal transaction amount riding in the transaction amount field.

In embodiments of the invention, the nominal transaction amount may serve as a command, such as a command to verify that a coupon holder has a coupon for a particular deal that he or she is attempting to redeem. Alternatively, the nominal transaction amount may serve as a command to allow access to information that requires the consent of the individual whose information is being sought. In such aspect, the particular amount of the nominal transaction may serve to indicate a method by which the information can be accessed. For example, a nominal transaction amount of two cents may indicate that the information should be sent in a particular way and/or to a particular destination, such as by fax to a particular fax number.

Thus, in embodiments of the invention, a message may be specified by the amount of the nominal transaction. A list of multiple different nominal amounts may be stored, for example, in a database and used to translate different nominal amounts to different messages. Each of a plurality of stored message may correspond to a particular nominal transaction amount. Embodiments of the invention provide multi-factor authentication. The foregoing healthcare sector example illustrates an example of a multi-factor authentication functionality. Utilizing the multi-factor functionality, the individual may authenticate himself or herself to the healthcare insurer's system with the individual's sixteen-digit number entered manually or by swiping a card in addition to entering his or her name.

An advantage of embodiments of the invention is that any sort of information, such as a command, may be communicated to a third party without changing the third party's hardware or software. Further, the sixteen digit number that identifies the individual is not limited to a unique sixteen-digit number that is used exclusively for the communication of information. For example, the individual may register his or her existing sixteen digit credit or debit card number for that purpose. When the individual's credit or debit card with the registered number is swiped for a nominal transaction amount, for example, between from one cent up to twenty or twenty-five cents, it may be recognized as a command instead of an actual transaction.

Such a transaction may be sent via a merchant acquirer and debit or credit card transaction card processing network to the recipient system from which information is sought. When the transaction is received, the recipient's system recognizes the card number that was previously registered, for example, on the recipient's web site. The recipient's system also recognizes that the transaction amount is a nominal amount, for example, of less than twenty or twenty-five cents and thus represents a command rather than an actual transaction. Based upon the identification of the point of sale terminal at which the transaction was entered and the particular nominal amount, the recipient's system can translate the command and respond appropriately.

Referring again to the healthcare sector example, when the individual's card is swiped at the healthcare provider's point of sale terminal and the nominal transaction amount is entered, the transaction is sent from the terminal to a merchant acquirer. The transaction is then sent from the merchant acquirer via an acquirer and a card transaction processing network, such as a card association card transaction processing network, to a command message processor. The command message processor recognizes the third party (i.e. the healthcare insurer), for example, from the BIN or range of BINs of the individual's card number and communicates in real time with the healthcare insurer's system.

Alternatively, in the case of a coupon redemption with a merchant, the command message processor recognizes, for example, from the BIN or range of BINs, that the third party is a particular coupon vendor and communicates in real time with the coupon vendor's system. In such case, the command message processor then sends a command to the coupon vendor's system with the sixteen-digit number and nominal transaction amount. The coupon vendor's system includes logic that looks at the sixteen-digit number and confirms the identity of the individual from the sixteen-digit number. The coupon vendor's system also looks at the nominal transaction amount and identifies the particular deal associated with the nominal amount. Finally, the coupon vendor's system verifies the validity of the coupon for the deal sought to be redeemed and sends an approval message back to merchant's terminal via the command message processor.

Referring once again to the healthcare sector example, when the user, such as a nurse, in the healthcare provider's office logs on the healthcare insurer's web site and asks for information about the individual, the user is prompted to authenticate that the individual is in the presence of the user. In response to such prompt, the user or the individual may swipe the individual's card with the sixteen-digit number at the healthcare provider's point of sale terminal. The user also enters a nominal transaction amount on the terminal and submits the transaction. The transaction is sent through the same channels as the foregoing coupon redemption transaction to the command message processor. As in the coupon redemption example, the command message processor recognizes, for example, from the BIN or range of BINs, that the third party is a particular healthcare insurer and communicates in real time with the healthcare insurer's system. The command message processor sends a command to the healthcare insurer's system with the sixteen-digit number and nominal transaction amount. The healthcare insurer's system looks at the sixteen-digit number and confirms the identity of the individual from the sixteen-digit number and also identifies the requesting party, i.e., the healthcare provider, from whose point of sale terminal the request originated. The healthcare insurer's system also looks at the nominal transaction amount and translates the nominal amount to a particular message, such as permission to allow the healthcare provider to access the individual's information. The user in the healthcare provider's office is then allowed to access the individual's information on the healthcare insurer's web site.

In the physical access aspect, it is common to require valid identification to enter certain premises to which access may be restricted or limited. Security issues may arise if an unauthorized person gains access to premises, such as a military base, using a means of identification that is bogus. In the physical access aspect, an individual's identification may be connected to a sixteen-digit number that is processable through a card transaction processing network, which may be more difficult for an unauthorized person to counterfeit. In such aspect, the individual's card with the sixteen-digit number may be swiped and a nominal transaction amount entered at a terminal deployed, for example, at the gate of a military base. Again, the transaction is sent through the same channels as the foregoing coupon redemption and healthcare sector transactions to a command message processor. Similar to the foregoing examples, the command message processor recognizes, for example, from the BIN or range of BINs, that the third party is a military system and communicates in real time with the military system. The command message processor sends a command to the military system with the sixteen-digit number and nominal transaction amount. The military system looks at the sixteen-digit number and confirms the identity of the individual from the sixteen-digit number and also identifies the particular terminal from which the transaction originated. The military system also looks at the nominal transaction amount and translates the nominal amount to a particular message, such as a request for permission to allow the individual physical access to the military base. The military system may send a message verifying the individual's identity to the point of sale terminal, and the individual may then be allowed to enter the military base.

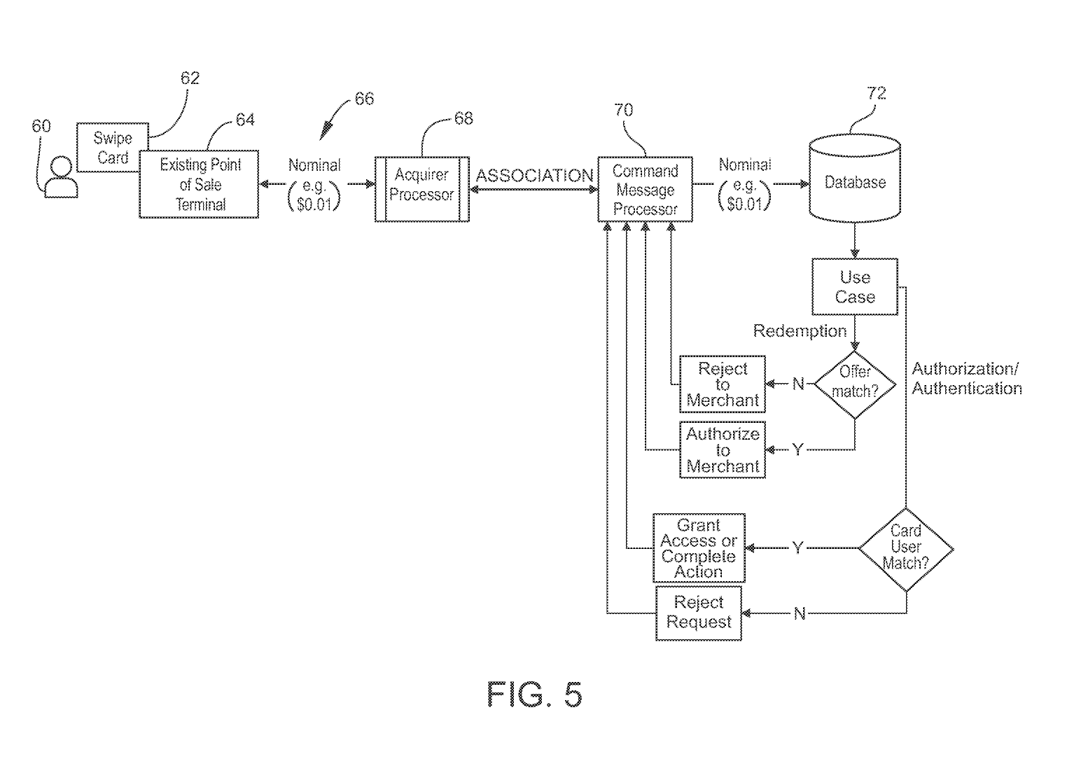

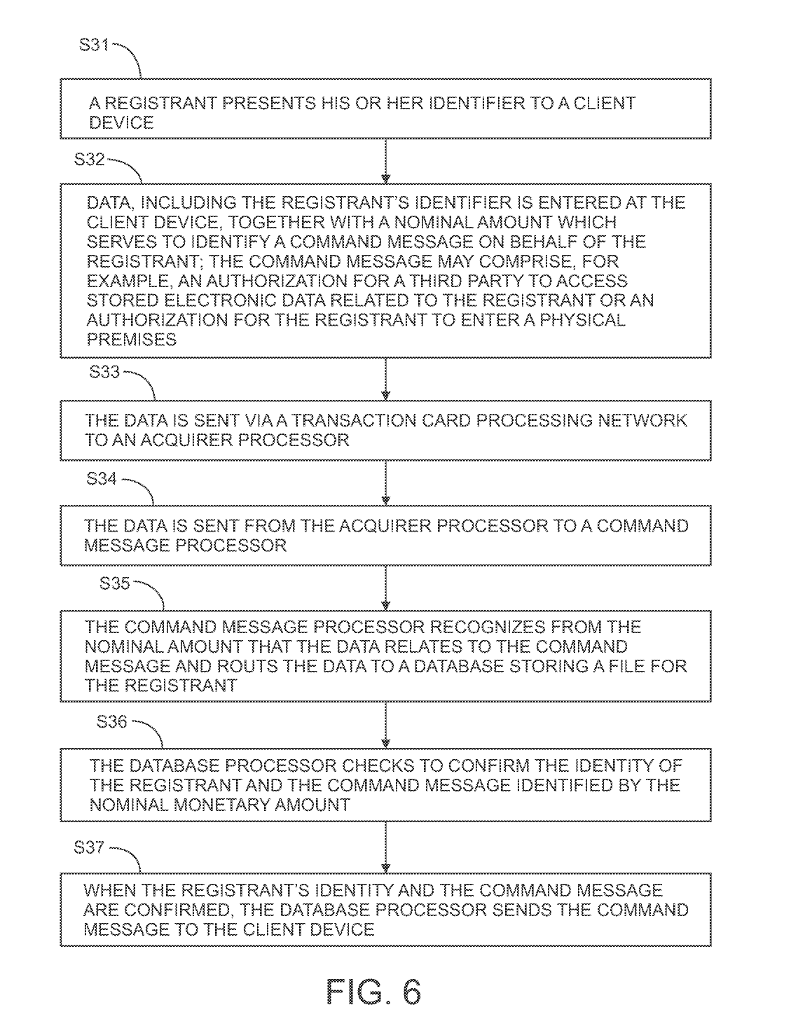

FIG. 5 is a schematic diagram that illustrates an overview example of key components and the flow of information between the key components of the messaging aspect system for allowing access to electronic information or allowing physical access to premises for embodiments of the invention. FIG. 6 is flow chart that illustrates an example of the process of messaging for allowing access to electronic information or allowing physical access to premises for embodiments of the invention. Referring to FIGS. 5 and 6, at S31, a registrant 60 may present his or her identifier, for example, on a mobile phone application or an account card to a client device 64, such as a merchant's point of sale terminal. The registrant's identifier may be a PAN number processable through a transaction card-processing network, such as a card association network. At S32, data, including the registrant's identifier may be entered at the client device 64, together with a nominal amount 66 which serves to identify a command message on behalf of the registrant 60. In the electronic information access aspect, the command message may comprise an authorization for a third party to access stored electronic data related to the registrant 60. In the physical premises aspect, the command message may comprise an authorization for the registrant 60 to enter a physical premises. While the nominal monetary amount is typically only a few cents, it may be some greater amount, but in no event greater than one dollar.

Referring further to FIGS. 5 and 6, at S33, the data is sent, using the client device processor 64, via a transaction card processing network, such as a card association network, to an acquirer processor 68. At S34, the data is sent, using the acquirer processor 68, to a command message processor 70. At S35, the command message processor 70 recognizes from the nominal amount that the data relates to the command message and routs the data to a database 72 storing a file for the registrant 60. At S36, the database processor 72 checks to confirm, for example, the identity of the registrant and the command message identified by the nominal monetary amount. At S37, when the registrant's identity and the command message are confirmed, the database processor sends the command message to the client device 64. The command message may be sent, for example, via the command message processor 70, the card transaction processing network, and the acquirer processor 68 to the client device 64.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that my be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices.

What is claimed is:

1. A method of electronic messaging, comprising:
receiving, by an issuer processor from a point of sale terminal processor via a transaction card processing network, data consisting at least in part of a consumer's identifier that is processable through a transaction card processing network and a nominal monetary amount which is an indicator that the data relates at least in part to a coupon redemption for a consumer;
recognizing, using the issuer processor, from the nominal monetary amount in the data that the data relates at least in part to the coupon redemption;
routing, using the issuer processor, the data to a database storing a file for the consumer with details of issuance of the coupon to the consumer;
confirming, using a database processor, from the stored file the details of issuance of the coupon to the consumer; and
sending, using the database processor, a message to the point of sale terminal processor authorizing the coupon redemption for the consumer.

2. The method of claim 1, wherein receiving the data consisting at least in part of the consumer's identifier further comprises receiving a consumer's membership account number from a consumer's membership account card.

3. The method of claim 2, wherein receiving the consumer's membership account number from the consumer's membership account card further comprises receiving the consumer's membership account number entered at the point of sale terminal by swiping the consumer's membership account card through the point of sale terminal.

4. The method of claim 3, wherein receiving the consumer's membership account number entered at the point of sale terminal by swiping the consumer's membership account card through the point of sale terminal further comprises receiving the consumer's membership account number entered at the point of sale terminal by swiping the consumer's membership account card through a special club terminal other than an unmodified pre-existing standard merchant's retail point of sale terminal.

5. The method of claim 4, wherein the special club terminal is wireless.

6. The method of claim 1, wherein receiving the data consisting at least in part of the consumer's identifier further comprises receiving a consumer's membership account number entered at the point of sale terminal from a mobile phone application.

7. The method of claim 1, wherein receiving the data consisting at least in part of the consumer's identifier further comprises receiving a consumer's membership account number printed on a computer printout.

8. The method of claim 1, wherein receiving the data consisting at least in part of the consumer's identifier further comprises receiving a consumer's membership account number that is identical to a credit or debit card account number of the consumer.

9. The method of claim 1, wherein receiving the data consisting at least in part of the nominal monetary amount further comprises receiving data representing a nominal monetary amount less than one dollar.

10. The method of claim 1, wherein receiving the data consisting at least in part of the nominal monetary amount further comprises receiving the data consisting at least in part of data representing a predetermined nominal monetary amount as an indicator that the data relates at least in part to a redemption of a coupon in a particular one of a plurality of different coupon programs.

11. The method of claim 1, wherein receiving the data by the issuer processor further comprises receiving the data by the issuer processor via a merchant's acquirer processor.

12. The method of claim 1, wherein the point of sale terminal processor further comprises a processor of a special club terminal other than an unmodified pre-existing standard merchant's retail point of sale terminal.

13. The method of claim 12, further comprising receiving, by the issuer processor from the special club terminal processor, data consisting at least in part of a monetary amount of an overage transaction to be charged against a credit or debit card account linked to a consumer's membership account.

14. The method of claim 13, wherein routing the data to the database further comprises routing the data to a coupon database storing a membership account file of the consumer that consists at least in part of details of the linked credit or debit card account of the consumer.

15. The method of claim 14, further comprising confirming, using the coupon database processor, that the issuer is authorized to function as a merchant's acquirer or has a working relationship with the merchant's acquirer.

16. The method of claim 15, further comprising routing, using the coupon database processor, the data to a credit card issuer processor.

17. The method of claim 16, further comprising confirming, using the credit card issuer processor, that the linked credit or debit card is in good standing and has sufficient credit limits to cover the overage amount.

18. The method of claim 17, wherein sending the message to the point of sale terminal processor authorizing the coupon redemption for the consumer further comprises sending, using the credit card issuer processor, the message authorizing the overage charge against the consumer's linked credit or debit card account.

19. A system for electronic messaging, comprising:
an issuer processor coupled to memory and being programmed for receiving, from a point of sale terminal processor via a transaction card processing network, data consisting at least in part of a consumer's identifier that is processable through the transaction card processing network and a nominal monetary amount which is an indicator that the data relates at least in part to a coupon redemption for the consumer;
the issuer processor being further programmed for recognizing from the nominal monetary amount in the data that the data relates at least in part to the coupon redemption and for routing the data to a database storing a file for the consumer with details of issuance of the coupon to the consumer; and
a database processor coupled to memory and being programmed for confirming from the stored file the details of issuance of the coupon to the consumer, the database processor being further programmed for sending a message to the point of sale terminal processor authorizing the coupon redemption for the consumer.

20. A non-transitory computer-readable storage medium with an executable program stored thereon, wherein the program instructs a microprocessor to perform the following steps:
receiving from a point of sale terminal via a transaction card processing network, data consisting at least in part of a consumer's identifier that is processable through the transaction card processing network and a nominal monetary amount which is an indicator that the data relates at least in part to a coupon redemption for the consumer;
recognizing from the nominal monetary amount in the data that the data relates at least in part to the coupon redemption;
routing the data to a database storing a file for the consumer with details of issuance of the coupon to the consumer;
confirming from the stored file the details of issuance of the coupon to the consumer; and
sending a message to the point of sale terminal authorizing the discount coupon redemption for the consumer.

21. A method of electronic messaging, comprising:
receiving, by a command message processor from a client device processor via a transaction card processing network, data consisting at least in part of an identifier for a registrant that is processable through the transaction card processing network and a nominal monetary amount which serves at least in part to identify a command message on behalf of the registrant;
recognizing, using the command message processor, from the nominal monetary amount in the data that the data relates at least in part to the command message;
routing, using the command message processor, the transaction data to a command message database storing a file for the registrant;
confirming, using a command message database processor, from the stored file an identity of the registrant and the command message identified by the nominal monetary amount;
sending, using the command message database processor, the command message to the client device processor on behalf of the registrant.

22. The method of claim 21, wherein the command message further comprises an authorization for a third party to access stored electronic data related to the registrant.

23. The method of claim 21, wherein the command message further comprises an authorization for the registrant to enter a physical premises.
